(19) United States
(12) Patent Application Publication
(10) Pub. No.: US 2020/0399743 A1
(43) Pub. Date: Dec. 24, 2020

(54) COMPOSITE MATERIALS BASED ON TUNGSTEN CARBIDE AND HAVING NOBLE METAL BINDERS, AND METHOD FOR PRODUCING SAID COMPOSITE MATERIALS

(71) Applicants: Universität Rostock, Rostock (DE); HNP Mikrosysteme GmbH, Schwerin (DE)

(72) Inventors: Carsten DAMERAU, Banzkow (DE); Wiktor BODNAR, Loitz (DE); Eberhard BURKEL, Rostock (DE)

(73) Assignees: Universität Rostock, Rostock (DE); HNP Mikrosysteme GmbH, Schwerin (DE)

(21) Appl. No.: 16/979,080

(22) PCT Filed: Mar. 8, 2019
(86) PCT No.: PCT/DE2019/100210

§ 371 Date: Sep. 8, 2020

(30) Foreign Application Priority Data
Mar. 9, 2018 (DE) 10 2018 105 489.0

(51) Int. Cl. C22C 29/06; C22C 29/08; B22F 3/105

(52) U.S. Cl. CPC C22C 29/067; C22C 29/08; B22F 2302/10; C04B 2235/666; B22F 3/105

(57) ABSTRACT

The invention relates to composite materials based on tungsten carbide and comprising gold, palladium and/or platinum and to a method for producing said composite materials by sintering. By means of the FAST method, hard and biocompatible WC/(Au, Pd, Pt) composite materials can be produced, inter alia for use as coatings on tools and prostheses and as solid bodies in, for example, blood pumps.

### INTRODUCTION

The invention concerns sintered composite materials based on tungsten carbide, incorporating the noble metals gold, platinum and/or palladium, and a method for producing these. It was found that the inventive method permits especially hard and biocompatible cemented carbides to be produced by sintering based on tungsten carbide using gold, platinum and/or palladium. Uses for these include as a nickel-free, wear-resistant hard design material for food processing or pharmaceutical machine components such as deflectors, nozzles and diaphragms and as a medical device material for implants or processing tools such as knives and scissors. Furthermore, these cemented carbides can be used as a coating for tools and protheses and as solid bodies for pumps in medical technology, for example.

### PRIOR ART

Cemented carbides are characterized by very high hardness, particularly at higher temperature, and buying good wear resistance. Tungsten carbides are particularly distinguished by extreme hardness and very good electrical conductivity as well heat conductivity Due to high wear resistance, such carbides have many uses and are used in industry particularly as a material for machine, punching and cutting tools.

Since tungsten carbide decomposes upon melting, mold bodies containing tungsten carbide can only be manufactured by sintering, with a combined method of sintering and hot isostatic pressing frequently being employed. Such cemented carbides are produced with various metal binder additives such as iron, cobalt and nickel, due to their good wettability, to influence the hardness, plasticity and fracture toughness.

A typical cemented tungsten carbide is frequently comprised of 85 to 94% tungsten carbide as reinforcement (main phase) and 6 to 15% cobalt or nickel (binding phase). The binder fills the interstitial spaces of the granules. However, instead of or in addition to cobalt and nickel, chromium is also suggested as a component of the binding phase. Along with nickel and chromium, EP 0028620 B1 mentions Ti, Zr, Hf, V, Nb and Ta as possible components of the binding phase.

Cemented tungsten carbide with Co/Ni in the binding phase tends toward detachment and embrittlement in contact with acids at a pH below 4 or if these alloys come in contact with oxiders or complexing agents. In these cases, the environment is contaminated with nickel and/or cobalt, which is why the potential use for tungsten carbide (WC) cemented with Co/Ni is limited.

For example, this characteristic considerably limits the use of such carbide parts in saws for processing fresh wood or in milling tools in coal mining. Furthermore, this characteristic and the low biocompatibility of cobalt and nickel practically exclude the use in medical, biological, food-related and pharmaceutical applications. Due to the presence of cobalt and/or nickel in the binding phase and the associated cytotoxicity, carbides based on WC have found no application up to now as a material for medical devices or implants.

An implant is an artificial material implanted in the body, which is intended to remain there permanently or at least a longer period of time. The need for implants and the requirements for functionality and biocompatibility have increased steadily in recent years. Implants are required to have the ability to incorporate quickly into bone and bond well with it. Modern implants should be mechanically stable and bond optimally and in a short time with the body's own tissue, causing neither rejection nor infection. However, nickel and nickel ions are classified as contact allergens, which is why metal carbides containing nickel cannot be used as implants.

The same also applies to medical tools or equipment. Thus extracorporeal blood pumps, for example as required in medical technology, must not contain cobalt or nickel due to cytotoxicity.

Most industrial applications are in conjunction with the hardness and wear resistance of cemented carbides. As a result of these characteristics, tungsten carbide, for example, is a suitable material for coating the working surfaces of tools. Cemented tungsten carbide coatings for the working surfaces of tools subject high stress are generally known industrial applications.

Since tungsten carbide decomposes upon melting, mold bodies containing tungsten carbide can only be manufactured by sintering, with a combined method of sintering and hot isostatic pressing frequently being employed.

DE 3128997 A1 discloses the production of composite materials containing tungsten carbide and noble metal by the hot isostatic pressing (HIP) method. However, no composite materials are disclosed which contain at least 80 weight percent WC and at least 2 weight percent of a noble metal. Furthermore, the method described therein leads to materials for the WC disclosed there and noble metal proportions to composite materials which contain a substantial quantity of W₂C as an impurity.

Known methods in powder metallurgy include Field Assisted Sintering Technology (FAST), also frequently referred to as Spark Plasma Sintering (SPS) or Pulsed Electric Current Sintering (PECS). This is an innovative pressure-assisted sintering process which works with pulsed direct current. Powder samples are exposed to this energy input for very brief periods of time (minutes instead of hours or days). In the course of FAST treatment, powder contained in a mold can be processed into various novel objects, such as nanostructured materials, fine ceramics, porous materials, etc.

### OBJECT OF THE INVENTION

The task of the invention is to create a carbide based on tungsten carbide, which combines high hardness, elasticity, corrosion resistance, resistance to acids and bases and biocompatibility with low technical manufacturing effort and expense in a suitable production method. A further task to be solved by the present invention consists of providing a composite material based on tungsten carbide which preferably contains less than 1 weight percent of W₂C.

### SUMMARY OF THE INVENTION

The task is inventively solved according to the features of the independent claims. Preferred embodiments are the subject matter of the dependent claims or are described below. The subject of the invention is a composite material based on tungsten carbide, i.e. comprised predominantly of tungsten carbide and also further comprising at least one or more noble metals selected from the group of gold, palladium and platinum, in which the composite material has or contains 80 weight percent to 98 weight percent tungsten carbide and 2 weight percent to 20 weight percent noble metals. The composite materials are carbides.

Sintered composite materials based on tungsten carbide with one or more of the noble metals Au, Pd or Pt in the binding phase—WC/(Au, Pd, Pt) exhibit surprising resistance both in strongly acid environments as well as in the presence of complexing agents and oxidizers, and constitute an interesting alternative to conventional tungsten carbides up to now due to the absence of cytotoxic cobalt and/or nickel ions. These characteristics of tungsten carbide equipped with a binding phase of gold or platinum or palladium offers new application possibilities. Such carbides find particular application as solid bodies in medical devices such as blood pumps and protheses and in food processing or pharmaceutical machine components such as deflectors, nozzles, amateurs or alloys for tools such as saws, lathe tools, tools for parting and grooving, and milling, drilling or reaming tools.

In contrast to the use of cobalt and/or nickel in the binding phase, the use of WC/(Au, Pd, Pt) composite materials in environments with a pH below about 4 does not lead to embrittlement or contamination of the environment with foreign metal ions such as Co or Ni ions. The same effect is observed in contact with liquids which contain complexing agents or oxidizers.

The inventive WC/(Au, Pd, Pt) composite materials, possibly also as a coating, find application for equipping the working surfaces of processing tools, for example in machining such as lathing, milling, drilling, sawing and grinding, or for non-machined shaping methods such as deep-drawing, cutting, punching or rolling.

The present invention particularly concerns pump heads for blood pumps as used in medical technology as well as permanent implants coated with WC/(Au, Pd, Pt) composite materials which are used in plastic or orthopedic surgery as a replacement for damaged or destroyed body parts, especially bones, or as dental implants.

According to the present invention, a method designated as FAST is preferably used for producing the WC/(Au, Pd, Pt) composite materials. It is a pressure-assisted sintering process with pulsed direct current. The starting materials for metal carbide production in the FAST process or at least pure or of such technical quality which is prepared as a mixture in a ball mill—for example, chromium carbide as a grain growth inhibitor, tungsten carbide powder and pure gold, palladium and/or platinum powder. In this process, the materials are mixed and/or reduced to particle sizes on the order of several microns down to a few nanometers. However, wet chemical- or CVD-coated metal carbide powder can also be used. The inventive composite materials produced according to the inventive method contain foreign atoms (those other than W, C, Au, Pd and/or Pt) at less than 3 atomic percent, such as the aforementioned chromium carbide as a grain growth inhibitor.

### DETAILED DESCRIPTION OF THE INVENTION

The inventive WC/(Au, Pd, Pt) composite materials are obtainable by sintering methods such as a combined sintering and hot isostatic pressing (HIP) process.

However, according to the present invention the FAST method is preferred for producing WC/(Au, Pd, Pt) composite materials. The advantages of the FAST method compared to those with high pressure or high temperatures for tungsten carbide compression are its comparatively low pressure on the MPa scale and high efficiency with a heating rate up to about 1000 K/min using pulsed direct currents in the range of thousands of amperes, and dwell time of a few minutes and a brief cooling phase. The method proposed here can be used for energy efficient production.

Furthermore, short processing time comprises a great advantage of the FAST method for producing WC/(Au, Pd, Pt) composite materials. This leads to a reduction of grain growth in the sintering process and a retention of nanostructures in the granularity of the material. This has positive effects on the mechanical properties of the material.

Furthermore, in producing the WC/(Au, Pd, Pt) composite materials by the FAST method, only a very small fraction—less than 1 weight percent—of a W₂C phase is formed, which is usually formed often in conventional sintering/HIP methods. The production method proposed here sharply reduces the negative influence on mechanical properties of the materials associated with the W₂C phase.

In the FAST method, the material to be processed is first placed in a matrix and then pressed. A pulsed direct current flows directly through the matrix and sample for heat input; its amperage and voltage depend on the electrical conductivity of the components, their size and the instantaneous sintering temperature. A significant increase of the compression rate is achieved for electrically conductive materials through the influence of the electric field and current flow. The compact design of the pressing tool enables heating rates of up to about 1000 K/min to be achieved.

The pre-compressed powders are introduced to the FAST chamber and then, for example, heated by the pulsed direct current to 1000° C. to 2000° C., in particular 1400° C. to 1800° C., under uniaxial pressure of 10 MPa to 300 MPa, in particular 50 MPa to 120 MPa, any vacuum or inert gas atmosphere.

Typically, amperage of 0.5 kA to 10 kA is selected in the course of the FAST method. Voltage in the process is relatively low: under 10 V, for example.

The advantages of the FAST method compared to those with high pressure or high temperatures for compression are its low pressure on the MPa scale and high-efficiency with the heating rate up to about 1000 K/min and preferably greater than 100 K/min, the dwell time of a few minutes, less than 20 minutes for example, and a short cooling phase; it is also possible to amid the dwell time (0 min) and transition directly to the cooling phase. The method proposed here can be used for energy efficient production.

This leads to a reduction of grain growth in the sintering process and a retention of nano- and microstructures in the granularity of the material. This has positive effects on the mechanical properties of the material.

WC composite materials are carbides with Au, Pd and/or Pt binding additives and are distinguished by their mechanical properties and their high hardness in particular. In the production method proposed here for a WC/(Au, Pd, Pt) composite material, the size distribution of grains in the sintered end product can be controlled very well with the use of powder grains of nanometer sizes. Hardly any uncontrolled grain growth occurred due to the short process times. The retention of nanostructure causes the Young modulus to exhibit no significant changes for materials sintered by the FAST method compared to conventionally produced WC/(Au, Pd, Pt) composite materials as well as significantly greater hardness.

A great advantage of the FAST method for producing metal carbide materials is the short process time.

The use of Co and Ni as a binding phase is omitted in the production method proposed here for a WC/(Au, Pd, Pt) composite material. This leads to greater biocompatibility of the carbide, reducing negative effects of the material on the human organism when used in the medical sector, industry or household routine. Particularly if the material is to be used in the medical sector, omitting binders such as cobalt or nickel is a great advantage, because the low biocompatibility of cobalt and nickel practically preclude the use in medical, biological, food-related and pharmaceutical applications. Using environments with a pH below about 4 leads to the binding, embrittlement and contamination of the environment with cobalt and nickel ions. The same effect occurs in contact with liquids which contain complexing agents or oxidizers. The proposed WC/(Au, Pd, Pt) composite materials thus exhibit greater biocompatibility.

In vitro studies with isolated leukocytes and lymphocytes from human blood showed that hard metal particles of cobalt and WC/Co induce dosage-dependent chromosome and DNA damage, while pure WC shows no dosage-dependent damage [F. Van Goethem et al., Mutation Research 392 (1997) 31-43].

Cytotoxicity studies with human embryonic kidney cells, human neuroepithelial cells, mouse myoblasts and the hippocampus primary neuronal cultures of WC cemented with Co and Ni and of pure W, Co and Ni have shown that cytotoxicity already occurs with concentrations of 50 ppm and that significant toxicity of nickel and cobalt occurs at nearly all concentrations tested [R. Verma et al., Toxicology and Applied Pharmacology 253 (2011) 178-187].

Surface coatings can be produced by sputtering, PVD, CVD, laser ablation or directly by FAST sintering. FAST in particular provides the possibility to produce sputter targets from WC/(Au, Pd, Pt) composite materials. The solid body produced can then be used directly as a corresponding sputter target.

### Embodiment

The method for producing the inventive sintered composite material of tungsten carbide and gold is described below with an example:

### 1. Production of a Sintered Composite Material of Tungsten Carbide and Gold.

23.75 g of tungsten carbide and 1.25 g of gold powder were ground in hexane in a ball mill for 2 hours at 200 rpm with a ball to powder ratio of 10:1. The powder mixture was dried and then transferred to the graphite mold of 20 mm diameter. The powder was processed in the graphite mold under vacuum in the FAST chamber. The initial pressure was 10 MPa. In the 15 minutes thereafter, the pressure was steadily increased to 100 MPa. The maximum applied pulsed direct current for the FAST method reached 2 kA and the voltage reached 5.3 V. The test piece was heated at a rate of 150 K/min to a temperature of 1600° C. The dwell time of the sintering process at 1600° C. was 5 min. After that the current was shut off but pressure was maintained on the test piece. After the sintering process was completed, any graphite residues were removed from the test piece using a sandblaster.

The progress of the sintering process for the composite material of tungsten carbide and gold produced as per Example 1 with 5 weight percent gold is shown in FIG. 1.

The sintering process produced a tungsten carbide and gold composite material with a relative density of 98.2% of the theoretical density.

2. Structure of the Test Piece from Example 1

With an initial size of 100 nm for the powder used in sintering at 1600° C., the resultant average grain size of the sintered material was 306 nm.

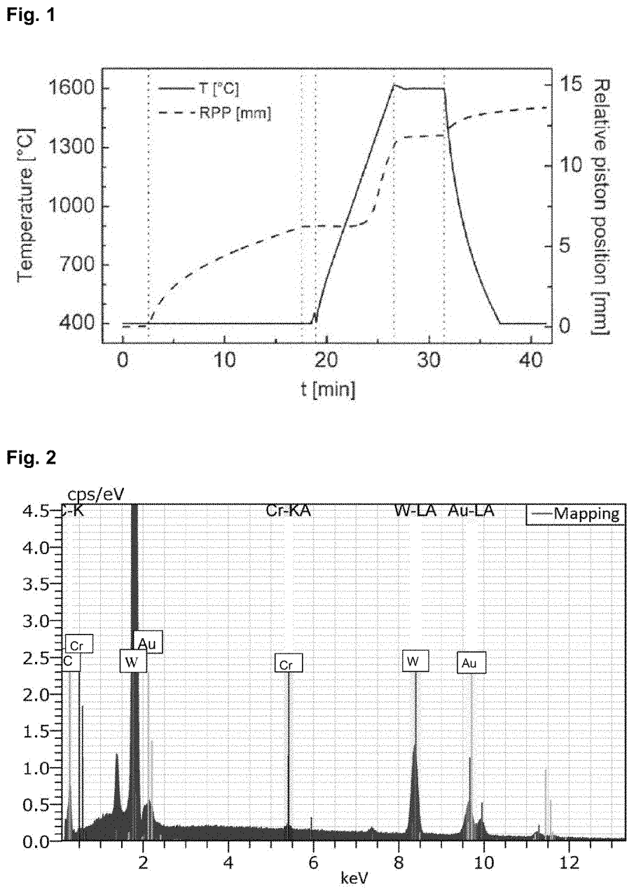

EDX structural investigations of the composite material from tungsten carbide and gold (FIG. 2) show only the presence of W, C, Cr, and Au in the sintered sample, so no contamination with other materials occurs during production and processing. In this regard, FIG. 2 shows the element mapping of the inner fracture image of the test piece from Example 1.

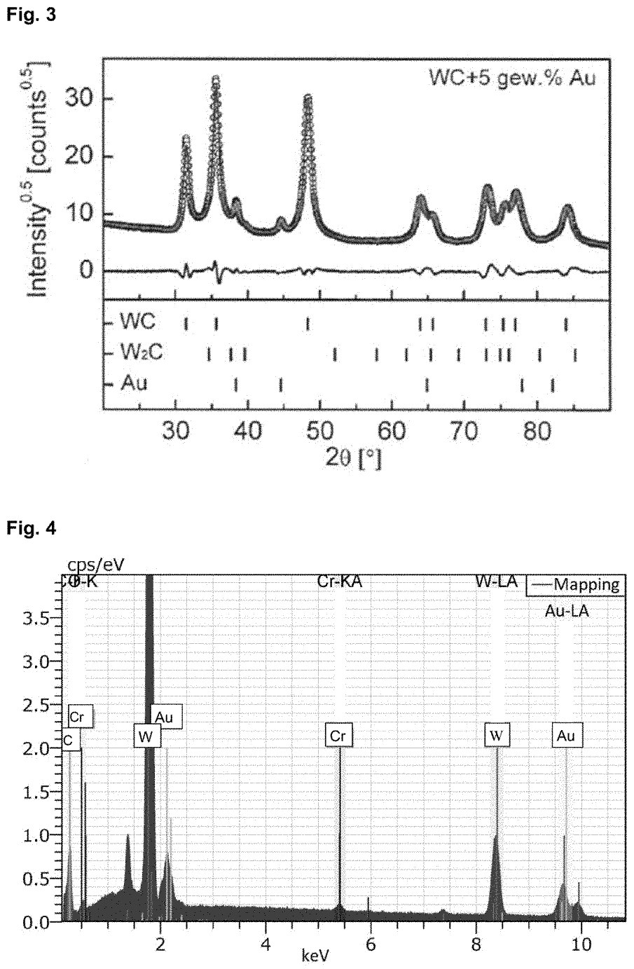

The X-ray diffractogram of the test piece (FIG. 3) confirms that a reduction of the usually occurring W₂C phase takes place as a result of the production process and incorporation of gold. This can be seen from the reduction of the main peak for W₂C. The calculated diffractogram and the difference with respect to the measured diffractogram are also shown. The Bragg reflexes of the phases which occur are shown in the lower part of FIG. 3.

3. Chemical Resistance of the Test Piece from Example 1

The stability of the composite material from tungsten carbide and gold was tested by treatment with potassium cyanide:

4Au+8KCN+O₂+2H₂O→4KAu(CN)₂+4KOH

Washing a sample in potassium cyanide solution gives an impression of the resistance of the material. A part of the test piece with a mass m=1.3705 g was placed in 60 mL of water with 100 mg of KCN for this The potassium cyanide solution with the part from the test piece was stirred continuously for five days. Afterward the sample was re-weighed and found to have a mass m* of 1.3665 g.

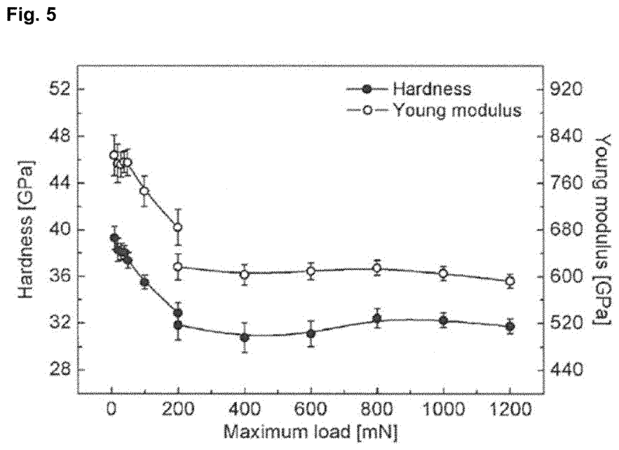

A high level of air inclusion was observed during the experiment. Since the reduction of mass for the test piece was not significant, the test piece was examined and EDX was carried out for the fracture edge. FIG. 4 shows the x-ray spectrum taken, which continued to show a significant fraction of Au along with W, C and Cr. This indicates that apparently only a small portion of the gold was dissolved from the surface of the sample. The structure remained unchanged in the interior of the test piece.

4. Biocompatibility of the Test Piece from Example 1

In order to evaluate the biocompatibility of the test piece from Example 1, the test piece was placed in a simulated body fluid with a pH of 7.25 for 8 weeks at 36.5° C. and shaken continuously. Then the solution was analyzed by atomic emission spectroscopy to determine the residues present.

The production of the simulated body fluid and the experimental procedure are described in more detail in
F. Zhang, E. Burkel. “Novel titanium manganese alloys and their macroporous foams for biomedical applications prepared by field assisted sintering”, Biomedical Engineering, Trends, Researches and Technologies, Rejeka: InTech (2011) 203-224

An overview of the W and Au residues found in the simulated body fluid solution after the end of storage is shown in the table below.

| Element | Wavelength [nm] | WC + 5% Au [ppm] |
|---|---|---|
| W | 220.448 | 1.45 |
| W | 239.709 | 1.46 |
| Au | 242.795 | <0.01 |
| Au | 267.595 | 0.03 |

After a long-term test of eight weeks, only concentrations below 1.5 ppm could be found in the solution, which ought to have a positive effect on applications in the medical sector.

5. Mechanical Properties of the Test Piece from Example 1

The mechanical properties of the test piece were investigated in a nanoindenter by the Berkovich method and in a microindenter by the Vickers method.

The Young modulus and hardness of the test pieces are also shown in FIG. 5. The data obtained by nanoindentation (load range 50-200 mN) and microindentation (load range 200-1200 mN) demonstrate the high hardness and outstanding Young modulus of the test piece. The difference in the results obtained for nano- and microindentation is due to the different measurement methods.

1. A composite material based on tungsten carbide, further comprising at least one or more noble metals selected from the group of gold, palladium and platinum, in which the composite material contains 80 weight percent to 98 weight percent tungsten carbide and 2 weight percent to 20 weight percent noble metals.

2. The composite material according to claim 1, in which the noble metal is palladium and/or platinum.

3. The composite material according to claim 1, consisting of 80 weight percent to 98 weight percent tungsten carbide and 2 weight percent to 20 weight percent noble metals and less than 3 atomic percent of other atoms.

4. The composite material according to claim 1, comprised of: 85 weight percent to 98 weight percent tungsten carbide and 2 weight percent to 15 weight percent noble metals, and less than 3 atomic percent of other atoms.

5. The composite material according to claim 1, which can be produced by sintering, in particular with the FAST method.

6. A method for producing the composite material according to claim 1 by sintering.

7. The method according to claim 6 by sintering with the FAST method, comprising the following steps:
providing a powder or powder mixture respectively, comprised of at least tungsten carbide and one or more noble metals,
exposing the powder or powder mixture respectively to
a voltage below 10 V,
a current from 0.5 kA to 10 kA, and
a pressure from 10 MPa to 300 MPa.

8. The method according to claim 6, in which the method is carried out in a vacuum or an inert gas atmosphere.

9. The method according to claim 6, in which the powder or powder mixture respectively is heated at a heating rate up to 1000 K/min, to 1000° C. to 2000° C., at a pressure of 10 MPa to 300 MPa, and is cooled afterward.

10. A working equipment having work surfaces coated or consisting of the composite material or comprising a machine component consisting of the composite material as a solid body according to claim 1.

11. The working equipment according to claim 10, in which the working equipment is a tool, a pump, part of a pump and in particular a pump head.

12. The working equipment according to claim 11, in which the pump is a pump for biological fluids.

13. The working equipment according to claim 10, in which the working equipment is an implant or a prosthesis and the body material of the implant or prosthesis is made of titanium or tantalum or alloys including titanium and/or tantalum and is coated with the composite material.

14. The working equipment according to claim 11, in which the tool, the pump, part of a pump or the pump head exist as a solid body made of the composite material.

15. The composite material according to claim 1, comprised of:
92 weight percent to 95 weight percent tungsten carbide and 5 weight percent to 8 weight percent noble metals and less than 3 atomic percent of other atoms.

16. The method according to claim 6, in which the powder or powder mixture respectively is heated at a heating rate of greater than 100 K/min to 1400° C. to 1800° C., at a pressure of 50 MPa to 120 MPa and is cooled afterward.

17. The working equipment according to claim 12, in which the biological fluids is blood.

18. The working equipment according to claim 11, in which the pump is a microfluidic pump.
